(19) United States
(12) Patent Application Publication
(10) Pub. No.: US 2025/0357608 A1
(43) Pub. Date: Nov. 20, 2025

(54) POWER STORAGE DEVICE

(71) Applicant: TOYOTA JIDOSHA KABUSHIKI KAISHA, Toyota-shi (JP)

(72) Inventors: Shigeyuki Inoue, Toyota-shi (JP); Keiji Kaita, Miyoshi-shi (JP)

(73) Assignee: TOYOTA JIDOSHA KABUSHIKI KAISHA, Toyota-shi (JP)

(21) Appl. No.: 19/180,634

(22) Filed: Apr. 16, 2025

(30) Foreign Application Priority Data
May 16, 2024 (JP) 2024-080010

(51) Int. Cl. H01M 50/291; H01M 10/613; H01M 10/658; H01M 50/204; H01M 50/317

(52) U.S. Cl. CPC H01M 50/291; H01M 10/613; H01M 10/658; H01M 50/204; H01M 50/317

(57) ABSTRACT

A power storage device includes: at least one power storage cell having a lower surface provided with a safety valve; a lower case having a bottom surface located below the at least one power storage cell; a spacer member provided between the bottom surface of the lower case and the at least one power storage cell to provide a space together with the bottom surface of the lower case; and a support member that supports the spacer member and receives a blast discharged from the safety valve. The spacer member has a through hole provided below the safety valve.

### CROSS REFERENCE TO RELATED APPLICATIONS

This nonprovisional application is based on Japanese Patent Application No. 2024-080010 filed on May 16, 2024 with the Japan Patent Office, the entire contents of which are hereby incorporated by reference.

### BACKGROUND

### Field

The present disclosure relates to a power storage device.

### Description of the Background Art

For example, Japanese National Patent Publication No. 2022-525014 discloses a power battery pack including a plurality of cells and a housing device. A case of each cell has a side surface provided with an external terminal and an explosion-proof valve.

### SUMMARY

In the power battery pack disclosed in Japanese National Patent Publication No. 2022-525014, when a short circuit or the like occurs in any one of the cells, high-temperature gas flows out from the explosion-proof valve in the cell. At this time, there is a concern that contents (what is called debris) of the cell may be discharged through the explosion-proof valve and adhere to an external terminal and the like.

An object of the present disclosure is to provide a power storage device in which contents of a power storage cell that are contained in gas discharged from a safety valve SV can be suppressed from adhering to the power storage cell.

A power storage device according to one aspect of the present disclosure includes: at least one power storage cell having a lower surface provided with a safety valve; a lower case having a bottom surface located below the at least one power storage cell; a spacer member provided between the bottom surface of the lower case and the at least one power storage cell to provide a space together with the bottom surface of the lower case; and a support member that supports the spacer member and receives a blast discharged from the safety valve. The spacer member has an opening provided below the safety valve.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a diagram schematically showing a vehicle including a power storage device in one embodiment of the present disclosure.

FIG. 2 is a perspective view schematically showing the power storage device and a frame member.

FIG. 3 is a cross-sectional view taken along a line III-III in FIG. 2.

FIG. 4 is a cross-sectional view taken along a line IV-IV in FIG. 3.

FIG. 5 is an enlarged cross-sectional view of a support member.

FIG. 6 is a perspective view schematically showing the support member.

FIG. 7 is a plan view schematically showing a cooler.

FIG. 8 is a cross-sectional view taken along a line VIII-VIII in FIG. 7.

FIG. 9 is a cross-sectional view schematically showing a modification of a spacer member and the support member.

FIG. 10 is a cross-sectional view schematically showing a modification of the spacer member and the support member.

FIG. 11 is a cross-sectional view schematically showing a modification of the spacer member and the support member.

### DESCRIPTION OF THE PREFERRED EMBODIMENTS

An embodiment of the present disclosure will be hereinafter described with reference to the accompanying drawings. In the drawings referred to below, the same or corresponding members are denoted by the same reference characters.

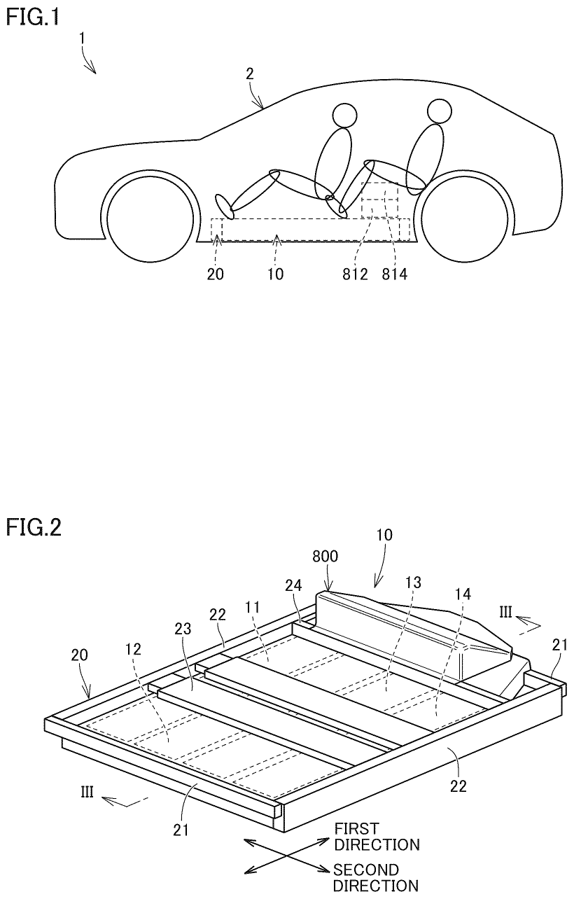

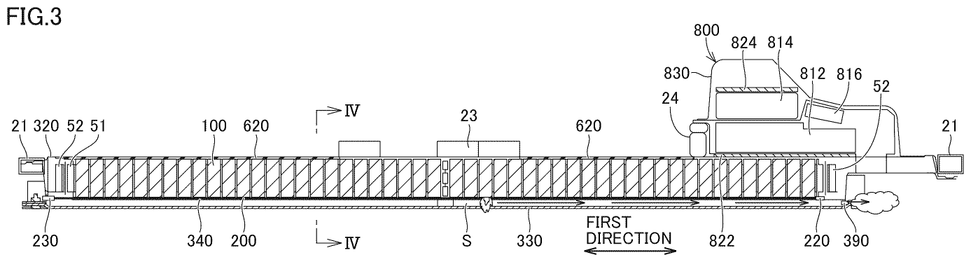

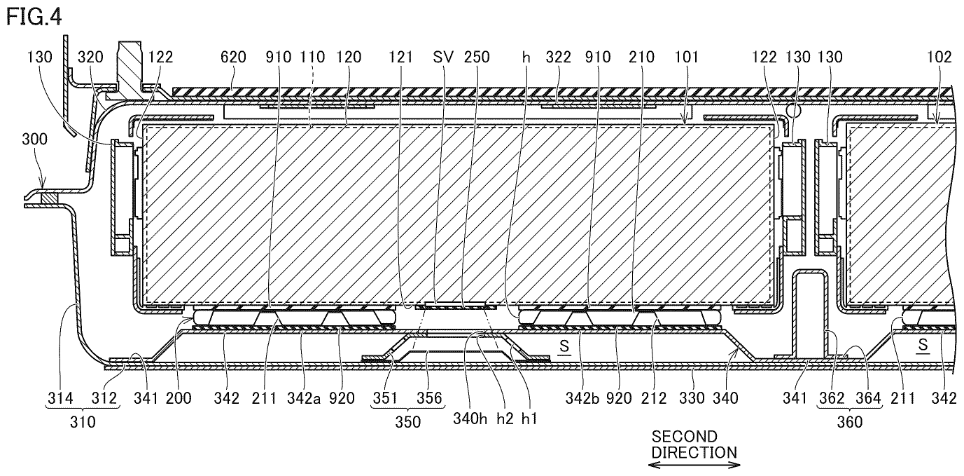

FIG. 1 is a diagram schematically showing a vehicle including a power storage device in one embodiment of the present disclosure. FIG. 2 is a perspective view schematically showing the power storage device and a frame member. FIG. 3 is a cross-sectional view taken along a line III-III in FIG. 2. FIG. 4 is a cross-sectional view taken along a line IV-IV in FIG. 3.

As shown in FIG. 1, a vehicle 1 includes a vehicle body 2 and a power storage device 10. Examples of vehicle 1 include a hybrid electric vehicle, a plug-in hybrid electric vehicle, and a battery electric vehicle.

As shown in FIGS. 1 and 2, vehicle body 2 includes a frame member 20. Frame member 20 is disposed on a bottom portion of vehicle body 2. Frame member 20 includes a pair of first frames 21, a pair of second frames 22, a first cross frame 23, and a second cross frame 24.

The pair of first frames 21 face each other in a first direction. Each first frame 21 is shaped to extend in a second direction orthogonal to both the first direction and an upward-downward direction. For example, the first direction may be parallel to a front-rear direction of vehicle 1, and the second direction may be parallel to a left-right direction (a width direction) of vehicle 1.

The pair of second frames 22 face each other in the second direction. Each second frame 22 is shaped to extend in the first direction. An end portion of each second frame 22 in the first direction is connected to first frame 21. The pair of second frames 22 are arranged in a substantially quadrangular cylindrical shape together with the pair of first frames 21 to surround power storage device 10.

First cross frame 23 is disposed between the pair of first frames 21 and couples the pair of second frames 22 to each other.

Second cross frame 24 is disposed between the pair of first frames 21 and couples the pair of second frames 22 to each other. Second cross frame 24 is spaced apart from first cross frame 23 in the first direction. Each of first cross frame 23 and second cross frame 24 forms, for example, a seat cross.

Power storage device 10 is attached to frame member 20. As shown in FIG. 2, power storage device 10 is disposed below first cross frame 23 and second cross frame 24. As shown in FIGS. 1 to 4, power storage device 10 includes four power storage stacks 11 to 14, a cooler 200, a housing 300, a reinforcement member 620, and a device unit 800. The number of power storage stacks is not limited to four.

Each of power storage stacks 11 to 14 includes at least one power storage cell 100. In the present embodiment, each of power storage stacks 11 to 14 includes a plurality of (for example, fifty) power storage cells 100 arranged side by side in the first direction. Each of power storage stacks 11 to 14 is formed in a rectangular parallelepiped shape elongated in the first direction. As shown in FIG. 2, four power storage stacks 11 to 14 are arranged side by side in the second direction.

As shown in FIG. 3, a pair of end plates 51 that sandwich the plurality of power storage cells 100 from both sides in the first direction are provided on both sides of the plurality of power storage cells 100 in the first direction. A monitoring unit (smart battery management) 52 is disposed outside each end plate 51 in the first direction.

As shown in FIG. 4, each power storage cell 100 has a shape longer in the second direction than in the first direction and the upward-downward direction. Each power storage cell 100 includes an electrode assembly 110, a cell case 120, and a pair of external terminals 130.

Electrode assembly 110 may be formed of a wound body implemented by winding a positive electrode sheet and a negative electrode sheet with a separator being interposed therebetween, or may be formed of a stacked body implemented by stacking a positive electrode sheet and a negative electrode sheet with a separator being interposed therebetween. Electrode assembly 110 is formed in a shape elongated in the second direction.

Cell case 120 accommodates electrode assembly 110. Cell case 120 is formed in a rectangular parallelepiped shape. Cell case 120 has a shape longer in the second direction than in the first direction and the upward-downward direction. Cell case 120 is made of metal such as aluminum. Cell case 120 includes a valve installation surface 121 and a terminal installation surface 122.

Valve installation surface 121 is provided with a safety valve SV. In the present embodiment, valve installation surface 121 is formed of a lower surface of cell case 120. In other words, safety valve SV is provided in the lower surface of cell case 120 in power storage cell 100. FIG. 4 shows two-dot chain lines indicating the discharge direction of the gas that may be discharged from safety valve SV.

External terminal 130 is provided on terminal installation surface 122. In the present embodiment, terminal installation surface 122 is formed of a side surface of cell case 120 in the second direction.

Each external terminal 130 is provided on terminal installation surface 122 (the side surface in the second direction in the present embodiment) of cell case 120. One of the pair of external terminals 130 is provided on terminal installation surface 122 on one side of cell case 120 in the second direction. The other of the pair of external terminals 130 is provided on terminal installation surface 122 on the other side of cell case 120 in the second direction.

Cooler 200 cools at least one power storage cell 100. In the present embodiment, cooler 200 cools each of power storage stacks 11 to 14. A cooling medium (oil or the like) flows through cooler 200.

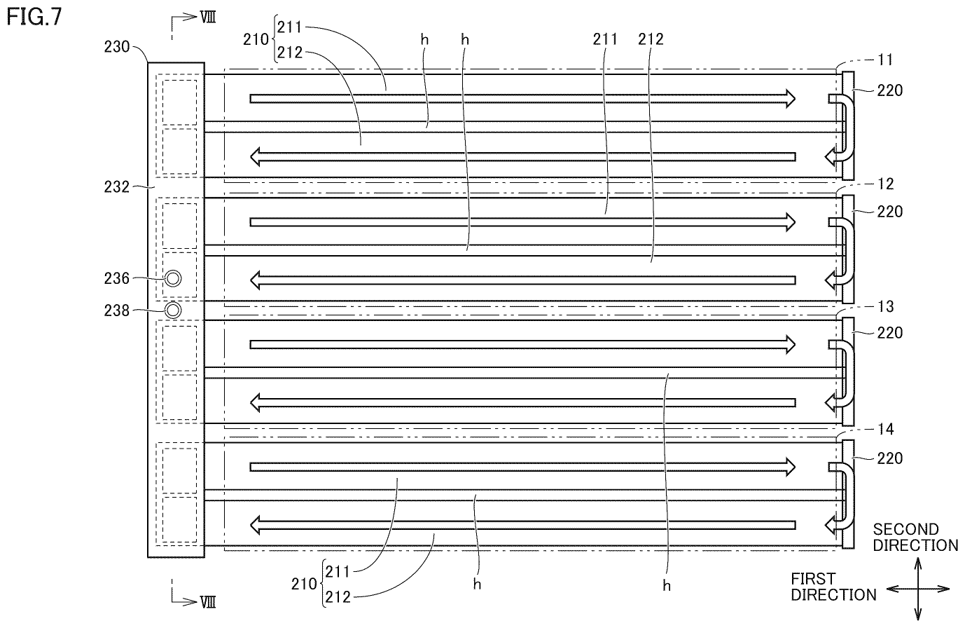

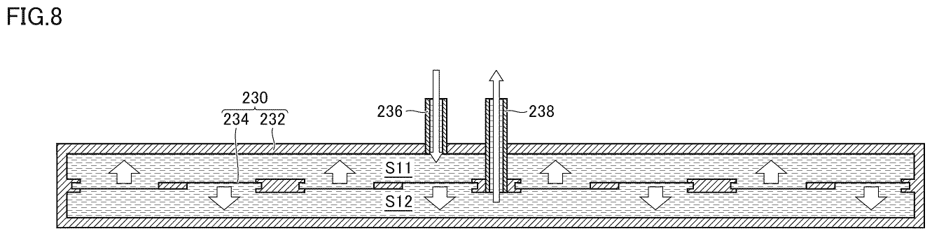

FIG. 7 is a plan view schematically showing the cooler. FIG. 8 is a cross-sectional view taken along a line VIII-VIII in FIG. 7. As shown in FIGS. 7 and 8, cooler 200 includes four cooling portions 210, a folded portion 220, and a coupling portion 230.

Each cooling portion 210 has a shape elongated in the first direction. Each cooling portion 210 cools one power storage stack. FIG. 7 shows two-dot chain lines indicating power storage stacks 11 to 14. As shown in FIG. 4, each cooling portion 210 is in thermal contact with valve installation surface 121 of each power storage cell 100. Each cooling portion 210 is in contact with valve installation surface 121 of each power storage cell 100 with a thermally conductive adhesive 910 being interposed therebetween. Thermally conductive adhesive 910 extends in the first direction. The state of being in thermal contact includes the state in which cooling portion 210 is in direct contact with valve installation surface 121 and the state in which cooling portion 210 is in indirect contact with valve installation surface 121 with a thermally conductive member (an adhesive, a fixing member, or the like) being interposed therebetween. Each cooling portion 210 may be formed by extrusion molding of metal such as aluminum. As shown in FIGS. 7 and 8, each cooling portion 210 includes an upstream flow path 211 and a downstream flow path 212.

Upstream flow path 211 is provided on the upstream side in the flow direction of the cooling medium. Downstream flow path 212 is provided on the downstream side in the flow direction of the cooling medium. As shown in FIG. 7, upstream flow path 211 and downstream flow path 212 each are shaped to extend in the first direction. Upstream flow path 211 and downstream flow path 212 are adjacent to each other in the second direction. The cooling medium flows through upstream flow path 211 from one side toward the other side in the first direction, and flows through downstream flow path 212 from the other side toward the one side in the first direction.

As shown in FIGS. 4 and 7, each cooling portion 210 is provided with a through hole h. Through hole h extends in the first direction. Through hole h is provided in cooling portion 210 and positioned to face safety valve SV of each power storage cell 100. The same number of through holes h as the number of power storage cells 100 in each power storage stack may be provided in cooling portion 210. Through hole h is provided in a portion of cooling portion 210 that is located between upstream flow path 211 and downstream flow path 212. In the present embodiment, through hole h is provided in a central portion of cooling portion 210 in the second direction.

Folded portion 220 couples a downstream end of upstream flow path 211 and an upstream end of downstream flow path 212. Thus, as indicated by arrows in FIG. 7, the cooling medium flows through upstream flow path 211, folded portion 220, and downstream flow path 212 in this order.

Coupling portion 230 couples four cooling portions 210 to each other. As shown in FIG. 8, coupling portion 230 includes a coupling portion main body 232 and a partition wall 234.

Coupling portion main body 232 couples four cooling portions 210 to each other. Thus, the cooling media having flowed through respective downstream flow paths 212 merge with each other inside coupling portion main body 232. Coupling portion main body 232 may be formed in a substantially rectangular parallelepiped shape.

Partition wall 234 partitions the inside of coupling portion main body 232 into two spaces. In the present embodiment, as shown in FIG. 8, partition wall 234 divides the inside of coupling portion main body 232 into two parts in the upward-downward direction. An upstream end of each upstream flow path 211 is connected to a space above partition wall 234 (the space will be hereinafter referred to as an “upstream space S11”) inside coupling portion main body 232, and a downstream end of each downstream flow path 212 is connected to a space below partition wall 234 (the space will be hereinafter referred to as a “downstream space S12”) inside coupling portion main body 232. Thus, the cooling medium having flowed into upstream space S11 flows into each upstream flow path 211. The cooling medium having flowed out of each downstream flow path 212 flows into downstream space S12.

As shown in FIGS. 7 and 8, an inflow portion 236 and an outflow portion 238 are connected to coupling portion 230.

Inflow portion 236 allows for communication between upstream space S11 inside coupling portion main body 232 and the outside of coupling portion main body 232. Thus, the cooling medium flows into upstream space S11 inside coupling portion main body 232 from the outside of coupling portion main body 232 through inflow portion 236. In the present embodiment, inflow portion 236 is connected to an upper surface of coupling portion main body 232.

Outflow portion 238 allows for communication between downstream space S12 inside coupling portion main body 232 and the outside of coupling portion main body 232. Thus, the cooling medium flows out of coupling portion main body 232 from downstream space S12 of coupling portion main body 232 through outflow portion 238. In the present embodiment, outflow portion 238 is connected to an upper portion of coupling portion main body 232 and partition wall 234. The cooling medium flowing out of coupling portion main body 232 through outflow portion 238 is higher in temperature than the cooling medium flowing into coupling portion main body 232 through inflow portion 236.

Housing 300 accommodates at least one power storage cell 100. In the present embodiment, housing 300 accommodates four power storage stacks 11 to 14 and cooler 200. As shown in FIG. 4, housing 300 includes a lower case 310, an upper cover 320, a panel member 330, a spacer member 340, a support member 350, and a cross member 360.

Lower case 310 is opened upward. Lower case 310 has a bottom surface 312 and a peripheral wall 314.

Bottom surface 312 is located below each of power storage stacks 11 to 14. Bottom surface 312 may be formed in a flat plate shape.

Peripheral wall 314 rises from a peripheral edge portion of bottom surface 312. Peripheral wall 314 is shaped to surround lower portions of power storage stacks 11 to 14.

Upper cover 320 is disposed above at least one power storage cell 100. In the present embodiment, upper cover 320 is disposed above four power storage stacks 11 to 14. Together with lower case 310, upper cover 320 accommodates four power storage stacks 11 to 14 and cooler 200. Specifically, together with lower case 310, upper cover 320 accommodates four power storage stacks 11 to 14 and cooler 200 in a hermetically sealed state. Upper cover 320 has a peripheral edge portion connected to a peripheral edge portion of lower case 310 with bolts or the like with a seal member being interposed therebetween.

Together with lower case 310, upper cover 320 accommodates the plurality of power storage cells 100. In the present embodiment, together with lower case 310, upper cover 320 accommodates four power storage stacks 11 to 14 and cooler 200 in a hermetically sealed state. Upper cover 320 has an upper wall 322 formed above power storage stacks 11 to 14. Upper wall 322 may be provided with beads extending in the second direction. Upper cover 320 has a peripheral edge portion connected to a peripheral edge portion of lower case 310 with bolts or the like with a seal member being interposed therebetween.

Panel member 330 is provided below lower case 310. Panel member 330 is joined to a lower surface of bottom surface 312. Panel member 330 has a function of protecting lower case 310. Panel member 330 may be formed in a flat plate shape.

Spacer member 340 provides a space S together with bottom surface 312 of lower case 310. Spacer member 340 is provided between bottom surface 312 of lower case 310 and at least one power storage cell 100. Specifically, spacer member 340 is provided between bottom surface 312 and each of power storage stacks 11 to 14. In other words, in the present embodiment, four spaces S are provided inside housing 300. Note that spacer member 340 and lower case 310 may be integrally formed.

Each space S functions as a smoke discharge path (hereinafter referred to as a “smoke discharge path S”). Smoke discharge path S serves as a path through which the gas discharged from safety valve SV is discharged to the outside of housing 300. Each smoke discharge path S is connected to a common space inside housing 300 at an end portion of smoke discharge path S in the first direction.

Spacer member 340 has an opening 340h provided below safety valve SV. When gas is discharged from safety valve SV of power storage cell 100, the gas flows into smoke discharge path S through opening 340h. In the present embodiment, opening 340h is provided in a portion of spacer member 340 that faces each safety valve SV.

As shown in FIG. 3, an explosion-proof valve 390 is provided in a portion of peripheral wall 314 that faces smoke discharge path S in the first direction. Explosion-proof valve 390 is provided in a common space inside housing 300. Explosion-proof valve 390 releases the pressure inside housing 300. Explosion-proof valve 390 opens when the pressure inside housing 300 becomes equal to or higher than a reference value. Explosion-proof valve 390 is formed of a check valve. As shown in FIG. 3, when gas is discharged from one of power storage cells 100, the gas spreads in the first direction through smoke discharge path S and is discharged to the outside of housing 300 through explosion-proof valve 390.

As shown in FIG. 4, spacer member 340 includes a base portion 341 and a cooler support portion 342.

Base portion 341 is connected to bottom surface 312 of lower case 310 by welding or the like. Base portion 341 is formed to be flat.

Cooler support portion 342 protrudes from base portion 341. Cooler support portion 342 supports cooler 200. In other words, cooler 200 is disposed between the lower surface of cell case 120 and spacer member 340. Cooler support portion 342 includes a first support portion 342a and a second support portion 342b.

First support portion 342a supports upstream flow path 211. More specifically, first support portion 342a supports upstream flow path 211 with an adhesive member 920 being interposed therebetween. First support portion 342a is formed in a flat plate shape.

Second support portion 342b supports downstream flow path 212. More specifically, second support portion 342b supports downstream flow path 212 with adhesive member 920 being interposed therebetween. Second support portion 342b is formed in a flat plate shape.

Opening 340h is provided in cooler support portion 342 and positioned to face through hole h of cooler 200.

As shown in FIG. 4, a heat insulation plate 250 may be provided on valve installation surface 121 of each cell case 120. Each heat insulation plate 250 is connected to valve installation surface 121 by an adhesive member or the like so as to cover safety valve SV. A notch may be provided in a portion of each heat insulation plate 250 that overlaps with an edge portion of safety valve SV. Each heat insulation plate 250 is made, for example, of mica obtained by hardening a natural inorganic mineral through heat pressing. Each heat insulation plate 250 may be placed on cooler support portion 342 so as to cover opening 340h.

Support member 350 supports spacer member 340. Support member 350 receives a blast discharged from safety valve SV. As shown in FIGS. 4 and 5, support member 350 includes a support portion 351 and a receiving portion 356. Note that FIG. 3 does not show support member 350.

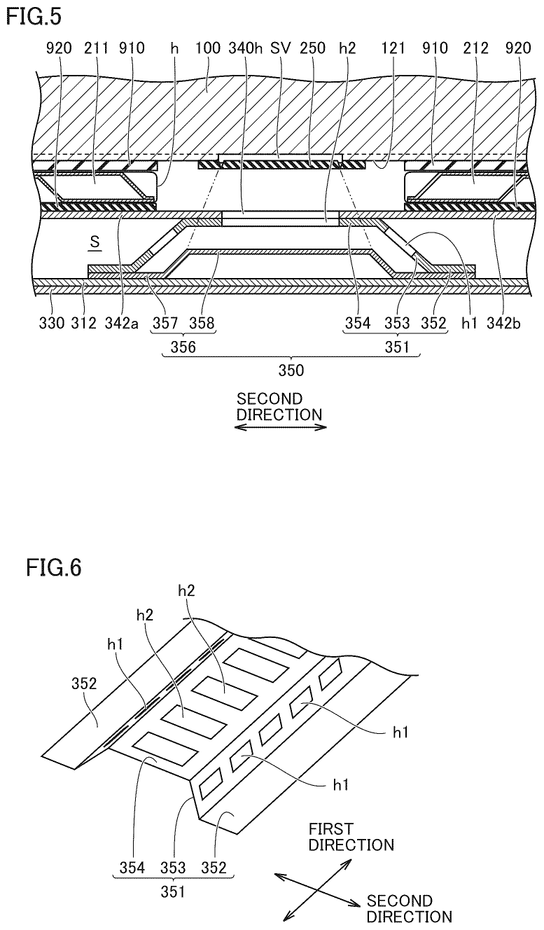

Support portion 351 supports a portion of spacer member 340 that is located around opening 340h. As shown in FIGS. 4 to 6, support portion 351 includes a pair of connection portions 352, a pair of rising portions 353, and a top portion 354.

The pair of connection portions 352 each are connected to bottom surface 312 of lower case 310 by welding or the like. The pair of connection portions 352 are spaced apart from each other in the second direction. Each connection portion 352 extends in the first direction. Each connection portion 352 is formed in a flat plate shape.

The pair of rising portions 353 each rise from connection portion 352. Each rising portion 353 rises from an inner end portion of connection portion 352 in the second direction. In the present embodiment, each rising portion 353 is inclined so as to gradually come close to each other with increasing distance upward from connection portion 352. Each rising portion 353 is provided with a communication port h1.

Top portion 354 extends from an upper end portion of rising portion 353 toward opening 340h. Top portion 354 connects the upper end portions of the pair of rising portions 353 to each other. Top portion 354 is in contact with a lower surface of cooler support portion 342. Top portion 354 is formed in a flat plate shape. An inlet port h2 is provided in a portion of top portion 354 that overlaps with opening 340h. The length of inlet port h2 in the second direction is set to be equal to or greater than the length of opening 340h in the second direction.

Receiving portion 356 receives a blast discharged from safety valve SV. Receiving portion 356 is located below opening 340h. Receiving portion 356 overlaps with top portion 354 in the upward-downward direction. Receiving portion 356 is disposed below inlet port h2. A length of receiving portion 356 at least in the second direction is greater than a length of opening 340h in the second direction. In the present embodiment, receiving portion 356 is formed of a member separate from support portion 351. However, receiving portion 356 may be formed integrally with support portion 351 and made of the same material as that of support portion 351. Receiving portion 356 is formed, for example, of a steel plate.

As shown in FIG. 5, receiving portion 356 includes a pair of interposed portions 357 and a receiving portion main body 358.

Each interposed portion 357 is interposed between bottom surface 312 of lower case 310 and connection portion 352. Each interposed portion 357 is connected to bottom surface 312 by welding or the like. Each interposed portion 357 is formed in a flat plate shape.

Receiving portion main body 358 couples the pair of interposed portions 357 to each other. Receiving portion main body 358 protrudes from the pair of interposed portions 357. Receiving portion main body 358 is spaced apart from bottom surface 312. Receiving portion main body 358 is formed in a flat plate shape. Receiving portion main body 358 is shaped to extend in the first direction. Receiving portion main body 358 overlaps with top portion 354 in the upward-downward direction and is disposed below inlet port h2. Receiving portion main body 358 is longer in the second direction than opening 340h.

Cross member 360 is connected by welding or the like to a portion of base portion 341 that is located between a pair of power storage stacks adjacent to each other. For example, FIG. 4 shows cross member 360 connected to base portion 341 provided in a portion between a plurality of first power storage cells 101 (see FIG. 4) included in power storage stack 11 disposed on the outermost side in the second direction and a plurality of second power storage cells 102 (see FIG. 4) included in power storage stack 12 adjacent to power storage stack 11. Cross member 360 extends in the first direction. Cross member 360 is connected to peripheral wall 314. Cross member 360 may be connected to the pair of first frames 21 through brackets (not shown).

As shown in FIG. 4, cross member 360 has a reinforcement portion 362 and a connection bottom surface 364.

Reinforcement portion 362 is shaped to protrude in a direction away from base portion 341. Reinforcement portion 362 is disposed below external terminal 130 of power storage cell 100. Reinforcement portion 362 overlaps in the upward-downward direction with both the pair of external terminals 130 facing each other in the second direction.

Connection bottom surface 364 extends outward in the second direction from a lower end portion of reinforcement portion 362. Connection bottom surface 364 is connected to base portion 341 by welding or the like. Connection bottom surface 364 is formed to be flat.

As shown in FIGS. 3 and 4, reinforcement member 620 is disposed on upper cover 320. More specifically, reinforcement member 620 is placed on upper wall 322. Reinforcement member 620 has a function of dispersing a load that locally acts on power storage device 10 from above by an occupant of vehicle 1.

Device unit 800 is disposed, for example, at an end portion in the first direction. In the present embodiment, device unit 800 is disposed on a rear portion of upper cover 320 in the front-rear direction of vehicle 1. Device unit 800 includes a junction box 812, an electricity supply unit 814, an electronic control unit 816, a first cooler 822, a second cooler 824, and a device cover 830.

Junction box 812 is disposed above upper cover 320. Junction box 812 accommodates relays, fuses, and the like. Junction box 812 is cooled by first cooler 822 disposed between junction box 812 and upper cover 320.

Electricity supply unit 814 is disposed above junction box 812. Electricity supply unit 814 is cooled by second cooler 824 disposed on electricity supply unit 814.

Electronic control unit 816 is disposed above junction box 812.

Device cover 830 accommodates junction box 812, electricity supply unit 814, electronic control unit 816, and second cooler 824.

In power storage device 10 described above, when gas is discharged downward from safety valve SV due to a short circuit or the like in any one of power storage cells 100, the gas breaks heat insulation plate 250 and flows into smoke discharge path S through opening 340h, inlet port h2, and communication port h1. Thus, the contents (what is called debris) of power storage cell 100 that are contained in the gas are suppressed from adhering to external terminal 130 and the like of power storage cell 100.

Further, valve installation surface 121 of power storage cell 100 is cooled by cooler 200, which suppresses breakage of valve installation surface 121 occurring when the gas flows out from safety valve SV.

The gas having flowed into smoke discharge path S spreads in the first direction and then is discharged from housing 300 through explosion-proof valve 390 as shown in FIG. 3. In this case, heat insulation plate 250 covers safety valve SV of each of other power storage cells 100 different from power storage cell 100 from which the gas has been discharged. Thereby, the blast discharged from safety valve SV is suppressed from bouncing back from spacer member 340 or the like and thereby coming into contact with safety valve SV of each of these other power storage cells 100. This consequently suppresses breakage of safety valve SV of each power storage cell 100 other than power storage cell 100 from which the gas has been discharged.

The following describes a modification of the above-described embodiment.

### <First Modification>

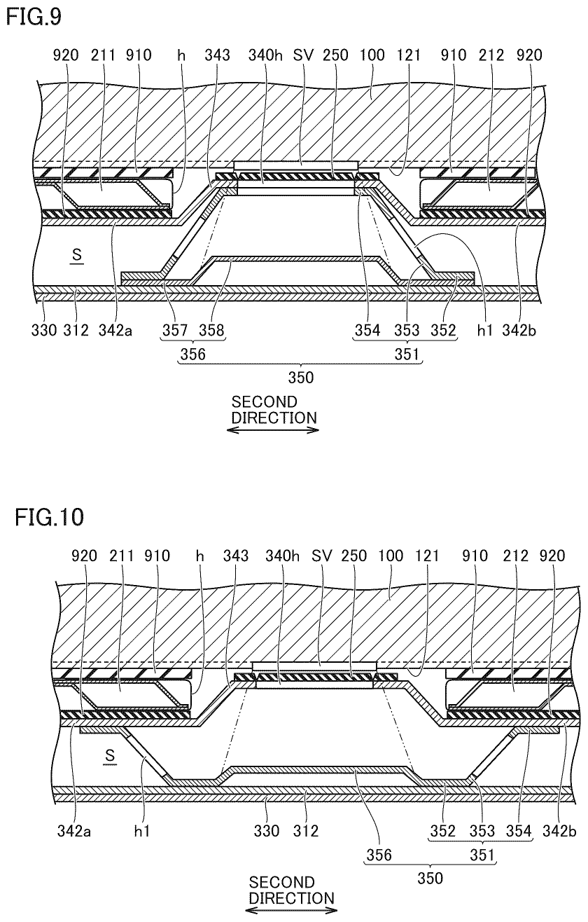

As shown in FIG. 9, spacer member 340 may include a protruding portion 343. Protruding portion 343 couples first support portion 342a and second support portion 342b. Protruding portion 343 protrudes from first support portion 342a and second support portion 342b. Protruding portion 343 is located inside through hole h of cooler 200. In other words, protruding portion 343 overlaps with upstream flow path 211 and downstream flow path 212 in the second direction. Opening 340h is provided in a portion of protruding portion 343 that faces safety valve SV.

Top portion 354 is in contact with a lower surface of protruding portion 343 that is located around opening 340h.

Heat insulation plate 250 may be placed on protruding portion 343.

In the present aspect, since the distance between safety valve SV and protruding portion 343 is relatively small, the blast discharged from safety valve SV is suppressed from coming into contact with cooler 200.

### <Second Modification>

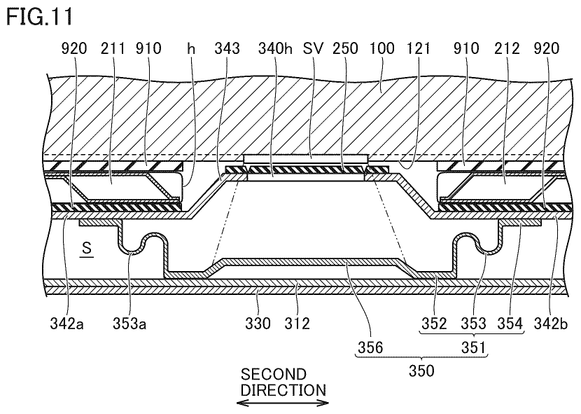

As shown in FIG. 10, support member 350 may have a pair of top portions 354. Each top portion 354 extends from the upper end portion of rising portion 353 in a direction away from opening 340h. One of the pair of top portions 354 supports first support portion 342a. The other of the pair of top portions 354 supports second support portion 342b.

Each rising portion 353 rises from an outer end portion of connection portion 352 in the second direction. In the present example, each rising portion 353 is inclined so as to be gradually spaced apart from each other with increasing distance upward from connection portion 352.

Receiving portion 356 couples the pair of connection portions 352 to each other. Receiving portion 356 is disposed below opening 340h. Receiving portion 356 may protrude so as to be spaced apart from bottom surface 312 of lower case 310.

### <Third Modification>

As shown in FIG. 11, each rising portion 353 may include a fragile portion 353a formed to be fragile. Fragile portion 353a absorbs energy resulting from an upward load that acts on bottom surface 312 of lower case 310. Fragile portion 353a elastically deforms so as to allow connection portion 352 and receiving portion 356 to be relatively displaced in the upward-downward direction with respect to top portion 354. Fragile portion 353a is smaller in thickness than connection portion 352 and top portion 354. Fragile portion 353a is broken by the gas discharged from safety valve SV to allow the gas to flow into smoke discharge path S.

In the present aspect, fragile portion 353a suppresses the load from being applied onto power storage cell 100 from below in the steady state, and also, the gas effectively flows into smoke discharge path S when the gas is discharged from safety valve SV.

It will be understood by those skilled in the art that the above-described exemplary embodiment is a specific example of the following aspects.

### [Aspect 1]

A power storage device including:
at least one power storage cell having a lower surface provided with a safety valve;
a lower case having a bottom surface located below the at least one power storage cell;
a spacer member provided between the bottom surface of the lower case and the at least one power storage cell to provide a space together with the bottom surface of the lower case; and
a support member that supports the spacer member, wherein
the spacer member has an opening provided below the safety valve.

In the present power storage device, the gas discharged downward from the safety valve of the power storage cell flows through the opening into the space provided between the bottom surface of the lower case and the spacer member. Thus, the contents (what is called debris) of the power storage cell that are contained in the gas is suppressed from adhering to the power storage cell. Further, the support member serves to support the spacer member and to protect the bottom surface of the lower case from the blast discharged from the safety valve.

### [Aspect 2]

The power storage device according to Aspect 1, wherein
the support member includes
   a support portion that supports a portion of the spacer member, the portion of the spacer member being located around the opening, and
   a receiving portion located below the opening.

### [Aspect 3]

The power storage device according to Aspect 2, wherein
the support portion includes
   a connection portion connected to the bottom surface of the lower case,
   a rising portion rising from the connection portion, and
   a top portion extending from an upper end portion of the rising portion toward the opening,
an inlet port is provided in a portion of the top portion, the portion of the top portion overlapping with the opening, and
the receiving portion overlaps with the top portion in an upward-downward direction and is disposed below the inlet port.

### [Aspect 4]

The power storage device according to Aspect 3, wherein the rising portion is provided with a communication port.

In the present aspect, the gas discharged from the safety valve flows into the space through the opening, the inlet port, and the communication port.

### [Aspect 5]

The power storage device according to Aspect 2, wherein
the support portion includes
   a connection portion connected to the bottom surface of the lower case,
   a rising portion rising from the connection portion, and
   a top portion extending from an upper end portion of the rising portion in a direction away from the opening, and
the receiving portion is contiguous to the connection portion and disposed below the opening.

### [Aspect 6]

The power storage device according to Aspect 5, wherein the rising portion is provided with a communication port.

In the present aspect, the gas discharged from the safety valve flows into the space through the opening and the communication port.

### [Aspect 7]

The power storage device according to any one of Aspects 3 to 6, wherein
the rising portion includes a fragile portion formed to be fragile, and
the fragile portion is broken by gas discharged from the safety valve to allow the gas to flow into the space.

In the present aspect, the fragile portion suppresses the load from being applied onto the power storage cell in the steady state, and also, the gas effectively flows into the smoke discharge path when the gas is discharged.

### [Aspect 8]

The power storage device according to any one of Aspects 2 to 7, wherein
the at least one power storage cell includes a plurality of power storage cells arranged side by side in a first direction,
each of the power storage cells has a shape longer in a second direction orthogonal to both the first direction and an upward-downward direction than in the first direction and the upward-downward direction, and
a length of the receiving portion at least in the second direction is greater than a length of the opening in the second direction.

In the present aspect, since the blast having passed through the opening is effectively received by the receiving portion, breakage of the bottom surface of the lower case is suppressed.

### [Aspect 9]

The power storage device according to any one of Aspects 1 to 8, further including a cooler for cooling the at least one power storage cell, wherein
the cooler is disposed between the lower surface of the at least one power storage cell and the spacer member, and is in thermal contact with the lower surface of the at least one power storage cell.

In the present aspect, the cooler cools the lower surface of the power storage cell, i.e., the surface provided with the safety valve, which therefore suppresses breakage of the lower surface occurring when the gas flows out from the safety valve.

### [Aspect 10]

The power storage device according to Aspect 9, wherein
the cooler has a through hole positioned to face the safety valve,
the spacer member includes
   a cooler support portion that supports the cooler, and
   a protruding portion protruding from the cooler support portion into the through hole of the cooler, and
the protruding portion is provided with the opening.

In the present aspect, since the distance between the safety valve and the protruding portion is relatively small, the blast discharged from the safety valve is suppressed from coming into contact with the cooler.

### [Aspect 11]

The power storage device according to Aspect 10, further including a heat insulation plate formed of a heat insulation member and placed on the protruding portion, wherein
the heat insulation plate covers the opening of the protruding portion.

In the present aspect, the heat insulation plate closes each opening positioned to face the safety valve of each of other power storage cells different from the power storage cell from which the gas has been discharged, and thereby, the gas spreading in the space is suppressed from coming into contact with the lower surface of each of these other power storage cells.

Although the embodiment of the present disclosure has been described, it should be understood that the embodiment disclosed herein is illustrative and non-restrictive in every respect. The scope of the present disclosure is defined by the terms of the claims, and is intended to include any modifications within the meaning and scope equivalent to the terms of the claims.

What is claimed is:

1. A power storage device comprising:
at least one power storage cell having a lower surface provided with a safety valve;
a lower case having a bottom surface located below the at least one power storage cell;
a spacer member provided between the bottom surface of the lower case and the at least one power storage cell to provide a space together with the bottom surface of the lower case; and
a support member that supports the spacer member, wherein
the spacer member has an opening provided below the safety valve.

2. The power storage device according to claim 1, wherein
the support member includes
a support portion that supports a portion of the spacer member, the portion of the spacer member being located around the opening, and
a receiving portion located below the opening.

3. The power storage device according to claim 2, wherein
the support portion includes
a connection portion connected to the bottom surface of the lower case,
a rising portion rising from the connection portion, and
a top portion extending from an upper end portion of the rising portion toward the opening,
an inlet port is provided in a portion of the top portion, the portion of the top portion overlapping with the opening, and
the receiving portion overlaps with the top portion in an upward-downward direction and is disposed below the inlet port.

4. The power storage device according to claim 3, wherein the rising portion is provided with a communication port.

5. The power storage device according to claim 2, wherein
the support portion includes
a connection portion connected to the bottom surface of the lower case,
a rising portion rising from the connection portion, and
a top portion extending from an upper end portion of the rising portion in a direction away from the opening, and
the receiving portion is contiguous to the connection portion and disposed below the opening.

6. The power storage device according to claim 5, wherein the rising portion is provided with a communication port.

7. The power storage device according to claim 3, wherein
the rising portion includes a fragile portion formed to be fragile, and
the fragile portion is broken by gas discharged from the safety valve to allow the gas to flow into the space.

8. The power storage device according to claim 2, wherein
the at least one power storage cell includes a plurality of power storage cells arranged side by side in a first direction,
each of the power storage cells has a shape longer in a second direction orthogonal to both the first direction and an upward-downward direction than in the first direction and the upward-downward direction, and
a length of the receiving portion at least in the second direction is greater than a length of the opening in the second direction.

9. The power storage device according to claim 1, further comprising a cooler for cooling the at least one power storage cell, wherein
the cooler is disposed between the lower surface of the at least one power storage cell and the spacer member, and is in thermal contact with the lower surface of the at least one power storage cell.

10. The power storage device according to claim 9, wherein
the cooler has a through hole positioned to face the safety valve,
the spacer member includes
a cooler support portion that supports the cooler, and
a protruding portion protruding from the cooler support portion into the through hole of the cooler, and
the protruding portion is provided with the opening.

11. The power storage device according to claim 10, further comprising a heat insulation plate formed of a heat insulation member and placed on the protruding portion, wherein
the heat insulation plate covers the opening of the protruding portion.
